(19) United States
(12) Patent Application Publication
(10) Pub. No.: US 2011/0097566 A1
(43) Pub. Date: Apr. 28, 2011

(54) POLYCARBONATE RESIN SHEET

(76) Inventor: Yuji Higaki, Tokyo (JP)

(21) Appl. No.: 13/001,859

(22) PCT Filed: Jun. 29, 2009
(86) PCT No.: PCT/JP2009/062238

§ 371 Date: Dec. 29, 2010

(30) Foreign Application Priority Data
Jul. 2, 2008 (JP) 2008-173257

(51) Int. Cl. B29D 7/01; B32B 27/28; B29C 47/00; B29C 47/88

(52) U.S. Cl. 428/220; 264/211.12

(57) ABSTRACT

A polycarbonate resin sheet which has a small heat shrinkage factor and small variations thereof and is useful for thermoforming and a production process therefor.

The sheet is made of a polycarbonate resin and has a thickness of 0.2 to 2.0 mm, a heat shrinkage factor in the extrusion direction (MD) of 2 to 8% when it is heated at 180° C. for 10 minutes and a standard deviation of heat shrinkage factor in the transverse direction (TD) of 1.5 or less.

### TECHNICAL FIELD

The present invention relates to a polycarbonate resin sheet having excellent dimensional stability and moldability at the time of thermoforming. More specifically, it relates to a polycarbonate resin sheet having excellent dimensional stability and shapability at the time of shrinkage as well as high impact resistance and transparency.

### BACKGROUND ART

Since polycarbonate resin is inexpensive and light in weight and has excellent transparency, moldability, optical properties, heat resistance, dimensional stability and mechanical strength, it is used in a wide variety of fields. Stated more specifically, it is used for various purposes such as car meter panel boards, instrument panels, membrane switch panels for home electric appliances (such as washing machines and microwave ovens), housing parts for mobile phones, dummy cans and dummy bottles.

However, to use the polycarbonate resin sheet for the above applications, it is strongly desired that it should have a good surface appearance, uniform and small dimensional changes at any part of the sheet at the time of thermoforming and excellent deep drawability.

The following characteristic properties are required especially for a thermoforming sheet for car meter panel boards. Firstly, it must have uniform shrinkage characteristics at any part of the sheet at the time of thermoforming, that is, small variations in heat shrinkage factor at any part of the sheet. Secondly, small variations in heat shrinkage factor must be obtained repeatedly in the thermoforming sheet. Thirdly, the heat shrinkage factor of the sheet must be small. In the fourth place, the shapability of the sheet must be excellent.

To produce a sheet having a good surface appearance, a sheet produced by both-side touch system in which a melt extruded sheet-like product is pressure held between two cooling rolls is superior to a sheet produced by one-side touch system in which a sheet-like product is directly held by one cooling roll without being pressure held between two cooling rolls. In the one-touch system, a die line stands out and the surface unevenness becomes large. In the one-touch system, though the heat shrinkage factor is small, the sheet does not have stretch-back properties at the time of thermoforming. Therefore, it is difficult to align the sheet at the time of thermoforming and the sheet is apt to crease.

Patent Document 1 proposes to limit the temperatures and speed ratio of cooling rolls so as the reduce the heat shrinkage factor of a polycarbonate resin sheet. This method employs the one-side touch system, and the obtained sheet has a little poor surface appearance and does not stretch back (??) at the time of thermoforming. Therefore, it is difficult to align the sheet and the sheet is apt to crease.

Patent Document 2 proposes to limit the viscosity average molecular weight of a polycarbonate resin and the temperatures of rolls at the time of production. This proposal is also a production process employing the one-side touch system, and the obtained sheet has a little poor surface appearance and is not tightened back at the time of thermoforming, whereby it is difficult to align the sheet and the sheet is apt to crease.

Patent Document 3 proposes a production process in which the temperatures and speed ratio of a plurality of cooling rolls are set so that tension is not applied to a sheet. In this process, it is difficult to extrude the sheet stably, which is industrially disadvantageous.

Therefore, with a production process employing the both-side touch system, the development of a sheet which has a good surface appearance, a small and uniform heat shrinkage factor at any part of the sheet and excellent moldability has been desired.

(Patent Document 1) JP-A 2001-212868

(Patent Document 2) JP-A 2006-316124

(Patent Document 3) JP-A 60-214923

### DISCLOSURE OF THE INVENTION

It is an object of the present invention to provide a polycarbonate resin sheet which has a small heat shrinkage factor and small variations in heat shrinkage factor and is useful for thermoforming application and a production process therefor.

The inventors of the present invention have studied a method of melting a polycarbonate resin and extruding it into a sheet form by pressure holding it on both sides (both-side touch system). They have found that a sheet which has small thickness variations in the transverse direction (TD) of the sheet, a good appearance, a small heat shrinkage factor and small variations thereof at any part of the sheet at the time of thermoforming is obtained by limiting the value of pressure to be applied to hold the sheet form to a specific range in the above method. The present invention has been accomplished based on this finding.

That is, the present invention includes the following inventions.

1. A sheet made of a polycarbonate resin and having a thickness of 0.2 to 2.0 mm, a heat shrinkage factor in the extrusion direction (MD) of 2 to 8% when it is heated at 180° C. for 10 minutes, and a standard division of heat shrinkage factor in the transverse direction (TD) of the sheet of 1.5 or less.

2. The sheet in the above paragraph 1 which has a standard deviation of thickness in the transverse direction (TD) of 8 or less.

3. A molded article obtained by thermoforming the sheet of the above paragraph 1.

4. A process for producing the sheet of the above paragraph 1, comprising the steps of:

(i) melt extruding a polycarbonate resin into a sheet form from a T die;

(ii) cooling the sheet by pressure holding it between cooling rolls; and
(iii) transferring the sheet by a transfer roll, wherein
   the rolling force at the time of pressure holding the sheet between the cooling rolls is 2 to 10 tons. 5. The process in the above paragraph 4, wherein there are first, second and third cooling rolls arranged in the extrusion direction, the polycarbonate resin is melt extruded between the first roll and the second roll, the temperature of the first roll is 105 to 120° C., the temperature of the second roll is 105 to 120° C., and the temperature of the third roll is 130 to 150° C.

### BRIEF DESCRIPTION OF THE DRAWINGS

FIG. 1 is a schematic diagram of a melt extruder for producing a sheet of the present invention; and

FIG. 2 is a schematic diagram of a melt extruder for producing a sheet of Comparative Example.

### EXPLANATION OF REFERENCE SYMBOLS

A die

D rubber roll

Q₁ first cooling roll

Q₂ second cooling roll

Q₃ third cooling roll

### BEST MODE FOR CARRYING OUT THE INVENTION

The present invention will be described in detail hereinunder.

### Polycarbonate Resin

The polycarbonate resin used in the present invention includes a polycarbonate resin obtained by polymerizing a carbonate prepolymer by solid-phase transesterification and a polycarbonate resin obtained by ring-opening polymerizing a cyclic carbonate compound besides a polycarbonate resin obtained by reacting a dihydric phenol with a carbonate precursor by interfacial polycondensation or melt transesterification.

Typical examples of the dihydric phenol used herein include hydroquinone, resorcinol, 4,4′-dihydroxydiphenyl, bis(4-hydroxyphenyl)methane, bis{(4-hydroxy-3,5-dimethyl)phenyl}methane, 1,1-bis(4-hydroxyphenyl)ethane, 1,1-bis(4-hydroxyphenyl)-1-phenylethane, 2,2-bis(4-hydroxyphenyl)propane (commonly known as “bisphenol A”), 2,2-bis{(4-hydroxy-3-methyl)phenyl}propane, 2,2-bis{(4-hydroxy-3,5-dimethyl)phenyl}propane, 2,2-bis{(3-isopropyl-4-hydroxy)phenyl}propane, 2,2-bis{(4-hydroxy-3-phenyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,4-bis(4-hydroxyphenyl)-2-methylbutane, 2,2-bis(4-hydroxyphenyl)pentane, 2,2-bis(4-hydroxyphenyl)-4-methylpentane, 1,1-bis(4-hydroxyphenyl)cyclohexane, 1,1-bis(4-hydroxyphenyl)-4-isopropylcyclohexane, 1,1-bis(4-hydroxyphenyl)-3,3,5-trimethylcyclohexane, 9,9-bis(4-hydroxyphenyl)fluorene, 9,9-bis{(4-hydroxy-3-methyl)phenyl}fluorene, α,α′-bis(4-hydroxyphenyl)-o-diisopropylbenzene, α,α′-bis(4-hydroxyphenyl)-m-diisopropylbenzene, α,α′-bis(4-hydroxyphenyl)-p-diisopropylbenzene, 1,3-bis(4-hydroxyphenyl)-5,7-dimethyladamantane, 4,4′-dihydroxydiphenylsulfone, 4,4′-dihydroxydiphenylsulfoxide, 4,4′-dihydroxydiphenylsulfide, 4,4′-dihydroxydiphenyl ketone, 4,4′-dihydroxydiphenyl ether and 4,4′-dihydroxydiphenyl ester. They maybe used alone or in combination of two or more.

A homopolymer or copolymer obtained from at least one bisphenol selected from the group consisting of bisphenol A, 2,2-bis{(4-hydroxy-3-methyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,2-bis(4-hydroxyphenyl)-4-methylpentane, 1,1-bis(4-hydroxyphenyl)-3,3,5-trimethylcyclohexane and α,α′-bis(4-hydroxyphenyl)-m-diisopropylbenzene is preferred. A homopolymer of bisphenol A and a copolymer of 1,1-bis(4-hydroxyphenyl)-3,3,5-trimethylcyclohexane and at least one monomer selected from bisphenol A, 2,2-bis{(4-hydroxy-3-methyl)phenyl}propane and α,α′-bis(4-hydroxyphenyl)-m-diisopropylbenzene are more preferred. A homopolymer of bisphenol A and a copolymer of 1,1-bis(4-hydroxyphenyl)-3,3,5-trimethylcyclohexane and α,α′-bis(4-hydroxyphenyl)-m-diisopropylbenzene are particularly preferred.

The carbonate precursor is a carbonyl halide, carbonate ester or haloformate, as exemplified by phosgene, diphenyl carbonate and dihaloformates of a dihydric phenol.

To produce a polycarbonate resin by reacting the above dihydric phenol with the above carbonate precursor by interfacial polycondensation or melt transesterification, a catalyst, a terminal capping agent and an antioxidant for the dihydric phenol may be optionally used. The polycarbonate resin may be a branched polycarbonate resin obtained by copolymerizing a polyfunctional aromatic compound having 3 or more aromatic groups, a polyester carbonate resin obtained by copolymerizing an aromatic or aliphatic bifunctional carboxylic acid, or a mixture of two or more of the obtained polycarbonate resins.

Examples of the polyfunctional aromatic compound having 3 or more aromatic groups include phloroglucin, phloroglucide, trisphenols such as 4,6-dimethyl-2,4,6-tris(4-hydroxyphenyl)heptene-2, 2,4,6-trimethyl-2,4,6-tris(4-hydroxyphenyl)heptane, 1,3,5-tris(4-hydroxyphenyl)benzene, 1,1,1-tris(4-hydroxyphenyl)ethane, 1,1,1-tris(3,5-dimethyl-4-hydroxyphenyl)ethane, 2,6-bis(2-hydroxy-5-methylbenzyl)-4-methylphenol and 4-{4-[1,1-bis(4-hydroxyphenyl)ethyl]benzene}-α,α-dimethy lbenzylphenol, tetra(4-hydroxyphenyl)methane, bis(2,4-dihydroxyphenyl)ketone, 1,4-bis(4,4-dihydroxytriphenylmethyl)benzene, and trimellitic acid, pyromellitic acid benzophenonetetracarboxylic acid and acid chlorides thereof. Out of these, 1,1,1-tris(4-hydroxyphenyl)ethane and 1,1,1-tris(3,5-dimethyl-4-hydroxyphenyl)ethane are preferred, and 1,1,1-tris(4-hydroxyphenyl)ethane is particularly preferred.

When the polyfunctional compound forming a branched polycarbonate resin is contained, its amount is preferably 0.001 to 1 mol%, more preferably 0.005 to 0.5 mol%, particularly preferably 0.01 to 0.3 mol% of the whole amount of the polycarbonate resin. Particularly in the case of melt transesterification, a branched structure may be produced as a side reaction. The amount of this branched structure is also preferably 0.001 to 1 mol%, more preferably 0.005 to 0.5 mol%, particularly preferably 0.01 to 0.3 mol% of the whole amount of the polycarbonate resin. The amount of the branched structure can be calculated by ¹H-NMR measurement.

The reaction by interfacial polycondensation is generally a reaction between a dihydric phenol and phosgene in the presence of an acid binder and an organic solvent. Examples of the acid binder include alkali metal hydroxides such as sodium hydroxide and potassium hydroxide, and amine compounds such as pyridine. Examples of the organic solvent include halogenated hydrocarbons such as methylene chloride and chlorobenzene. A catalyst such as a tertiary amine, a quaternary ammonium compound or a quaternary phosphonium compound as exemplified by triethylamine, tetra-n-butylammonium bromide and tetra-n-butylphosphonium bromide may be used to promote the reaction. The reaction temperature is generally 0 to 40° C., the reaction time is about 10 minutes to 5 hours, and pH during the reaction is preferably kept at 9 or more.

A terminal capping agent is generally used in the polymerization reaction. A monofunctional phenol may be used as the terminal capping agent. The monofunctional phenol is generally used as a terminal capping agent to control the molecular weight. The obtained polycarbonate resin is superior in heat stability to a polycarbonate resin whose terminals are not capped by a group derived from a monofunctional phenol. The monofunctional phenol is generally phenol or a lower alkyl-substituted phenol as exemplified by phenol, p-tert-butylphenol, p-cumylphenol and isooctylphenol.

The terminal capping agent is desirably introduced into at least 5 mol%, preferably at least 10 mol% of the total of all the terminals of the obtained polycarbonate resin. More preferably, it is introduced into not less than 80 mol% of the total of all the terminals, that is, the content of the terminal hydroxyl group (OH group) derived from the dihydric phenol is not more than 20 mol%. Particularly preferably, the terminal capping agent is introduced into not less than 90 mol% of total of all the terminals, that is, the content of the OH group is not more than 10 mol%. The terminal capping agents may be used alone or in combination of two or more.

The reaction by melt transesterification is generally a transesterification reaction between a dihydric phenol and a carbonate ester. The dihydric phenol and the carbonate ester are mixed together in the presence of an inert gas under heating while the formed alcohol or phenol is distilled off. The reaction temperature which differs according to the boiling point of the formed alcohol or phenol is generally 120 to 350° C. In the latter stage of the reaction, the pressure of the reaction system is reduced to 1.33×10³ to 13.3 Pa to facilitate the distillation-off of the formed alcohol or phenol. The reaction time is generally about 1 to 4 hours.

The carbonate ester is an ester such as aryl group or aralkyl group having 6 to 10 carbon atoms which may be substituted, or alkyl group having 1 to 4 carbon atoms. Examples of the carbonate ester include diphenyl carbonate, bis(chlorophenyl) carbonate, dinaphthyl carbonate, bis(diphenyl) carbonate, dimethyl carbonate, diethyl carbonate and dibutyl carbonate. Out of these, diphenyl carbonate is preferred.

A polymerization catalyst may be used to accelerate the polymerization rate. The polymerization catalyst is a catalyst which is generally used in an esterification reaction or a transesterification reaction, as exemplified by alkali metal compounds such as sodium hydroxide, potassium hydroxide and sodium salts and potassium salts of a dihydric phenol, alkali earth metal compounds such as calcium hydroxide, barium hydroxide and magnesium hydroxide, nitrogen-containing basic compounds such as tetramethylammonium hydroxide, tetraethylammonium hydroxide, trimethylamine and triethylamine, alkoxides of an alkali metal or an alkali earth metal, organic acid salts of an alkali metal or an alkali earth metal, zinc compounds, boron compounds, aluminum compounds, silicon compounds, germanium compounds, organic tin compounds, lead compounds, osmium compounds, antimony compounds, manganese compounds, titanium compounds and zirconium compounds. These catalysts may be used alone or in combination of two or more. The amount of the polymerization catalyst is preferably 1×10⁻⁸ to 1×10⁻³ equivalent, more preferably 1×10⁻⁷ to 5×10⁻⁴ equivalent based on 1 mole of the dihydric phenol as one of the raw materials.

To reduce the number of phenolic terminal groups in the polymerization reaction, a compound such as bis (chlorophenyl) carbonate, bis (bromophenyl) carbonate, bis (nitrophenyl) carbonate, bis (phenylphenyl) carbonate, chlorophenylphenyl carbonate, bromophenylphenyl carbonate, nitrophenylphenyl carbonate, phenylphenyl carbonate, methoxycarbonylphenylphenyl carbonate or ethoxycarbonylphenylphenyl carbonate may be added in the latter stage or at the end of the polycondensation reaction. Out of these, 2-chlorophenylphenyl carbonate, 2-methoxycarbonylphenylphenyl carbonate and 2-ethoxycarbonylphenylphenyl carbonate are preferred, and 2-methoxycarbonylphenylphenyl carbonate is particularly preferred.

Further, a deactivator is preferably used to neutralize the activity of the catalyst in the polymerization reaction. Examples of the deactivator include sulfonic acid esters such as benzenesulfonic acid, p-toluenesulfonic acid, methyl benzenesulfonate, ethyl benzenesulfonate, butyl benzenesulfonate, octyl benzenesulfonate, phenyl benzenesulfonate, methyl p-toluenesulfonate, ethyl p-toluenesulfonate, butyl p-toluenesulfonate, octyl p-toluenesulfonate and phenyl p-toluenesulfonate, trifluoromethanesulfonic acid, naphthalenesulfonic acid, sulfonated polystyrene, methyl acrylate-sulfonated styrene copolymer, 2-phenyl-2-propyl dodecylbenzenesulfonate, 2-phenyl-2-butyl dodecylbenzenesulfonate, octylsulfonic acid tetrabutylphosphonium salts, decylsulfonic acid tetrabutylphosphonium salts, benzenesulfonic acid tetrabutylphosphonium salts, dodecylbenzenesulfonic acid tetraethylphosphonium salts, dodecylbenzenesulfonic acid tetrabutylphosphonium salts, dodecylbenzenesulfonic acid tetrahexylphosphonium salts, dodecylbenzenesulfonic acid tetraoctylphosphonium salts, decylammonium butyl sulfate, decylammonium decyl sulfate, dodecylammonium methyl sulfate, dodecylammonium ethyl sulfate, dodecylmethylammonium methyl sulfate, dodecyldimethylammonium tetradecyl sulfate, tetradecyldimethylammonium methyl sulfate, tetramethylammonium hexyl sulfate, decyltrimethylammonium hexadecylsulfate, tetrabutylammonium dodecylbenzyl sulfate, tetraethylammonium dodecylbenzyl sulfate and tetramethylammonium dodecylbenzyl sulfate. The deactivator is not limited to these. These compounds may be used in combination of two or more. Out of these deactivators, phosphonium salts and ammonium salts are preferred.

The amount of the deactivator is preferably 0.5 to 50 moles based on 1 mole of the residual catalyst. The deactivator is used in an amount of preferably 0.01 to 500 ppm, more preferably 0.01 to 300 ppm, particularly preferably 0.01 to 100 ppm based on the polycarbonate resin after polymerization.

The molecular weight of the polycarbonate resin is not particularly limited. The molecular weight of the polycarbonate resin is preferably 1.5×10⁴ to 4.0×10⁴ in terms of viscosity average molecular weight (M). It is more preferably 1.7×10⁴ to 3.0×10⁴, much more preferably 1.8×10⁴ to 2.8×10⁴, particularly preferably 2.0×10⁴ to 2.5×10⁴. A polycarbonate resin having a viscosity average molecular weight (M) of 1.5×10⁴ to 4.0×10⁴ has high strength and moldability. Two or more polycarbonate resins having different molecular weights may be used in combination. The viscosity average molecular weight (M) in the present invention is obtained by inserting the specific viscosity (ηₛₚ) of a solution prepared by dissolving 0.7 g of the polycarbonate resin in 100 ml of methylene chloride at 20° C. into the following equation.

ηₛₚ/c=[η]+0.45×[η]²c

([η] represents an intrinsic viscosity)

[η]=1.23×10⁻⁴M^{0.83}

c=0.7

Additives and an inorganic filler may be added to the polycarbonate resin in amounts that develop their effects as long as the object of the present invention is not impaired. The additives may include thermoplastic resins except for the polycarbonate resin. The thermoplastic resins include polyolef in-based resins such as polyester resin, polysulfone resin, polyether ether ketone resin, polyphenylene sulfide resin, polyphenylene ether resin, polyethylene resin and polypropylene resin, styrene-based resins such as polystyrene resin, ABS resin, AS resin and MBS resin, polyamide resin, acrylic resin and thermoplastic elastomers (such as styrene-based, olefin-based, urethane-based, polyester-based, polyamide-based, 1,2-polybutadiene-based, vinyl chloride-based, fluorine-based [fluorine rubber], ionomer resin, chlorinated polyethylene and silicone-based elastomers). The additives further include a flame retardant (such as brominated bisphenol, brominated polystyrene, carbonate oligomer of brominated bisphenol A, triphenyl phosphate, resorcinol bis(dixylenylphosphate), bisphenol A bis(diphenyl phosphate), red phosphorus or organic sulfonic acid alkali metal salt), flame retardant aid (such as sodium antimonate or antimony trioxide), dripping inhibitor (such as polytetrafluoroethylene having fibril formability), antioxidant (such as hindered phenol-based compound), heat stabilizer (such as phosphorus-based compound), ultraviolet absorbent, antistatic agent, release agent, lubricant and colorant. Examples of the inorganic filler include glass beads, talc and mica.

A sheet can be manufactured by mixing together the polycarbonate resin and the additives by means of a mixer such as a tumbler, twin-cylinder mixer, Nauter mixer, Banbury mixer, kneading roll or extruder and melt extruding the resulting mixture.

### Heat Shrinkage Factor in Extrusion Direction (MD)

The polycarbonate resin sheet of the present invention has a small heat shrinkage factor and small variations thereof. That is, when the sheet is heated at 180° C. for 10 minutes, its heat shrinkage factor in the extrusion direction (MD) is 2 to 8% preferably 3 to 7%. When the heat shrinkage factor falls within this range, pattern misalignment after thermoforming becomes small advantageously. The standard deviation of heat shrinkage factor in the extrusion direction (MD) is preferably 1.0 or less, more preferably 0.8 or less, much more preferably 0.5 or less. Although the lower limit is preferably 0, it may be 0.3 or more for practical use. When the standard deviation of heat shrinkage factor falls within the above range, shrinkage characteristics after thermoforming become uniform advantageously.

### Heat Shrinkage Factor in Transverse Direction (TD)

The heat shrinkage factor in the transverse direction (TD) of the sheet is preferably 2 to 10%, more preferably 3 to 8%. When the heat shrinkage factor falls within this range, pattern misalignment after thermoforming becomes small advantageously. The standard deviation of heat shrinkage factor in the transverse direction (TD) of the sheet is 1.5 or less, preferably 1.2 or less, more preferably 1.0 or less. Although the lower limit is preferably 0, it may be 0.7 or more for practical use. When the standard deviation of heat shrinkage factor falls within the above range, shrinkage characteristics after thermoforming become uniform advantageously.

### Thickness

The thickness of the polycarbonate resin sheet of the present invention is 0.2 to 2.0 mm, preferably 0.2 to 1.5 mm, more preferably 0.3 to 1.0 mm. When the thickness is smaller than 0.2 mm, extrusion moldability degrades and when the thickness is larger than 2.0 mm, moldability at the time of thermoforming degrades.

The standard deviation of thickness in the transverse direction (TD) of the sheet is preferably 8 or less, more preferably 5 or less. Although the lower limit is preferably 0, it maybe 3 or more for practical use. When the standard deviation of thickness falls within the above range, uniform shapability becomes excellent advantageously.

### Sheet Production Process

In the process for producing a polycarbonate resin sheet with three cooling rolls whose rotation center axes are parallel to one another and existent on the same plane and which are arranged close to one another by extruding a molten polycarbonate resin from the T die of an extruder into a sheet form, when the sheet form is pressure held between a first cooling roll and a second cooling roll at the center while it is supplied between the first cooling roll and the second cooling roll (both-side touch system) and let pass through a gap between the second cooling roll and a third cooling roll at the other end to be taken up, pressure (rolling force) to be applied to the cooling rolls for pressure holding the sheet is set to 2 to 10 tons.

The rolling force is preferably 2 to 8 tons, more preferably 2.5 to 6 tons. When the rolling force is smaller than 2 tons, it is difficult to form a resin pool (bank) uniformly and a poor appearance may result. When the rolling force is larger than 10 tons, variations in heat shrinkage factor in the transverse direction (TD) of the sheet become large, thereby deteriorating dimensional stability at the time of molding.

The rolling force is applied only between the first roll and the second roll, and the space between the second roll and the third roll is wider than the thickness of the sheet and not applied by pressure.

As for the temperatures of the three cooling rolls, preferably, the temperature of the first roll is 105 to 125° C., the temperature of the second roll is 105 to 125° C., and the temperature of the third roll is 130 to 150° C. Preferably, the surfaces of the first to third cooling rolls are planished, and a heat medium circulates in these cooling rolls to control their temperatures. The apparatus used for this purpose does not need to be special, and any apparatus which is used for the production of a sheet or a film is used.

To adjust the heat shrinkage factor of the sheet, a method of adjusting the speeds of the cooling rolls and the take-up roll, the speeds of the first cooling roll and the second cooling roll which pressure hold the sheet, or the temperatures of the cooling rolls is effective.

### Thermoformed Article

According to the present invention, there are provided various molded articles such as car meter panel boards, instrument panels, membrane switch panels for home electric appliances (such as washing machines and microwave ovens), housing parts for mobile phones, dummy cans and dummy bottles all of which are obtained by thermoforming the obtained polycarbonate resin sheet.

The polycarbonate resin sheet may be suitably subjected to known surface treatments such as embossing, UV exposure, antistatic coating and blocking prevention coating.

### EXAMPLES

The following examples are provided to further illustrate the present invention. Characteristic properties in the examples were measured by the following methods.

(1) Heat shrinkage factor

The heat shrinkage factors of sheets having a thickness of 0.5 mm or 0.4 mm obtained in Examples and Comparative Examples were measured.

(i) Maximum and minimum values and standard deviation of heat shrinkage factor in transverse direction (TD)

A total of six 150 mm square test samples were taken out from a center portion of a 900 mm-wide sheet in the transverse direction (TD) to measure their heat shrinkage factors. The heat shrinkage factor was obtained by measuring the short diameter of a deformed circle (oval) after a 100 mm-diameter circle was drawn on each of the test samples with a compass and the sample was placed on a flat Teflon (registered trademark) plate in a hot air drier to be heated at 180° C. for 10 minutes in accordance with JIS K6735.

The heat shrinkage factor (R^{TD}) was calculated from the following equation.

R^{TD}=(L₀^{TD}−L₁^{TD})×100

L₀^{TD}: length in transverse direction before treatment=100 mm
L₁^{TD}: length in transverse direction after treatment

This measurement was repeated 4 times to obtain maximum and minimum values.

The spread of the measurement data of heat shrinkage factor of a total of 24 points was expressed by standard deviation and evaluated.

◯: excellent dimensional stability with a standard deviation of heat shrinkage factor of a total of 24 points of 1.0 or less

Δ: slightly low dimensional stability with a standard deviation of heat shrinkage factor of a total of 24 points of more than 1.0 and 1.5 or less

×: low dimensional stability with a standard deviation of heat shrinkage factor of a total of 24 points of more than 1.5

(ii) Maximum and minimum values and standard deviation of heat shrinkage factor in extrusion direction (MD)

A total of ten 150 mm square test samples were taken out from a center portion of a 900 mm-wide sheet in the extrusion direction (MD) to measure their heat shrinkage factors. The heat shrinkage factor was obtained by measuring the short diameter of a deformed circle (oval) after a 100 mm-diameter circle was drawn on each of the test samples with a compass and the sample was placed on a flat Teflon (registered trademark) plate in a hot air drier to be heated at 180° C. for 10 minutes so as to obtain the maximum and minimum values of heat shrinkage factor in accordance with JIS K6735.

The heat shrinkage factor (R^{MD}) was calculated from the following equation.

R^{MD}=(L₀^{MD}−L₁^{MD})×100

L₀^{MD}: length in extrusion direction before treatment=100 mm
L₁^{MD}: length in extrusion direction after treatment

The spread of the measurement data was expressed by standard deviation and evaluated.

◯: excellent dimensional stability with a standard deviation of heat shrinkage factor of a total of 10 points of 0.5 or less

Δ:slightly low dimensional stability with a standard deviation of heat shrinkage factor of a total of 10 points of more than 0.5 and 1.0 or less

×: low dimensional stability with a standard deviation of heat shrinkage factor of a total of 10 points of more than 1.0

(2) Maximum and minimum values and standard deviation of thickness

The thicknesses in the transverse direction (TD) of sheets having a thickness of 0.5 mm or 0.4 mm obtained in Examples and Comparative Examples were measured with a thickness meter to obtain maximum and minimum values and standard deviation.

### Measurement Method

The thickness of the sheet at measurement points in the transverse direction was measured. The measurement was made on a 900 mm-wide sheet at a total of 37 points which were 25 mm apart from one another in the transverse direction.

◯: excellent extrusion stability with a standard deviation of thickness of 5 or less

Δ: slightly low extrusion stability with a standard deviation of thickness of more than 5 and 8 or less

×: low extrusion stability with a standard deviation of thickness of more than 8

(3) Foreign matter

Samples having a width of 900 mm in the transverse direction (TD) and a length of 500 mm in the extrusion direction (MD) were taken out from sheets having a thickness of 0.5 mm or 0.4 mm obtained in Examples and Comparative

Examples and projected with a projector to measure the size of a shadow on a white plate so as to measure the size of foreign matter and calculate the actual area of the foreign matter from its projection size using the impurity measurement chart of the Finance Ministry. The distance between the horizontal white plate and the sheet was 14 cm.

When the actual area is represented by S (mm²), it is evaluated as follows.

◯: no foreign substances satisfying S≧0.3, and 2 or less foreign substances satisfying 0.1≦S<0.3

Δ: 1 or less foreign substance satisfying S≧0.3, and 5 or less foreign substances satisfying 0.1≦S<0.3

×: 2 or more foreign substances satisfying S≧0.3, or 6 or more foreign substances satisfying 0.1≦S<0.3

(4) Die line

Samples having a width of 900 mm in the transverse direction (TD) and a length of 500 mm in the extrusion direction (MD) were taken out from sheets having a thickness of 0.5 mm or 0.4 mm obtained in Examples and Comparative Examples, and a die line projected on a white plate by a projector was checked visually. The distance between the horizontal white plate and the sheet was 14 cm.

◯: no die line is seen

Δ: a thin die line is seen

×: a thick die line is seen

### EXAMPLES 1 TO 4 AND COMPARATIVE EXAMPLES 1 AND 2

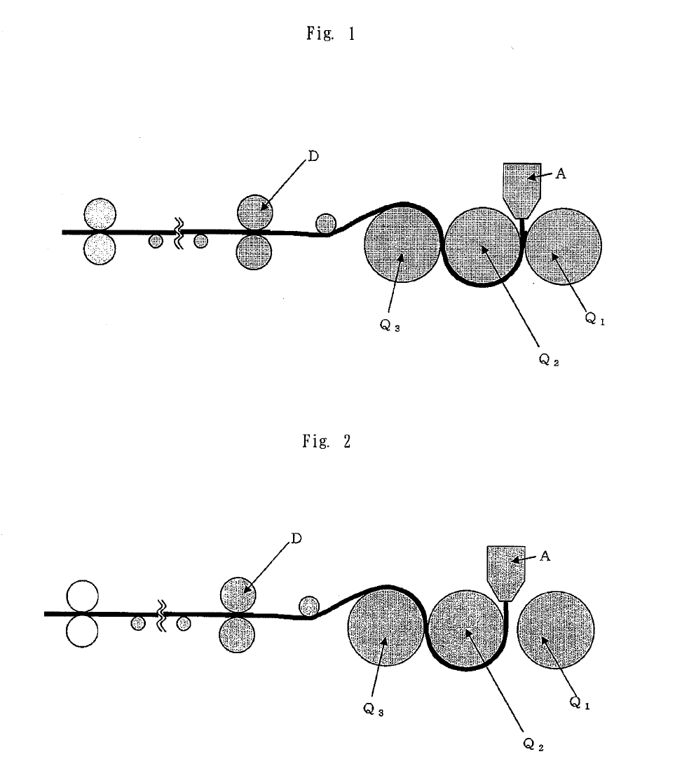

A sheet was manufactured by an extruder equipped with devices shown in FIG. 1. A T die having a width of 1,200 mm and first, second and third cooling rolls having a diameter of 300 mm and a mirror surface were used, and polycarbonate resin powders having a viscosity average molecular weight of 24,000 produced from bisphenol A and phosgene by interfacial polymerization were extruded from the T die set to 280° C. at a delivery rate of 280 kg/hr. The molten resin extruded from the T die was pressure held between the first cooling roll and the second cooling roll at a pressure shown in Table 1 in accordance the both-side touch system and further cooled with the third cooling roll, the both end portions of the sheet were trimmed, and the resin was extruded to obtain a sheet having a width of 900 mm.

The temperatures of the first, second and third cooling rolls were set to 115° C., 115° C. and 145° C., respectively.

The rolling force at the time of pressure holding the sheet was obtained by measuring the value of a load cell at the left end of the first cooling roll and the value of a load cell at the right end of the first cooling roll. The characteristic properties of the obtained sheet are shown in Table 1.

### Comparative Example 3

A sheet was manufactured by an extruder equipped with devices shown in FIG. 2. A T die having a width of 1,200 mm and first, second and third cooling rolls having a diameter of 300 mm and a mirror surface were used, and polycarbonate resin powders having a viscosity average molecular weight of 24,000 produced from bisphenol A and phosgene by interfacial polymerization were extruded from the T die set to 280° C. at a delivery rate of 280 kg/hr. The molten resin extruded from the T die was dropped on and contacted to the second roll and further cooled with the third cooling roll in accordance with the one-side touch system, the both end portions of the sheet were trimmed, and the resin was extruded to obtain a sheet having a width of 900 mm. The temperatures of the second and third cooling rolls were set to 135° C. and 140° C., respectively. The characteristic properties of the obtained sheet are shown in Table 1.

TABLE 1

| | | Rolling force | | Heat shrinkage factor (%) in MD direction | | | |
|---|---|---|---|---|---|---|---|
| | Thickness | (t) | | | | | Evaluation of |
| | of sheet | Left | Right | Maximum | Minimum | Standard | standard |
| | (mm) | end | end | value | value | deviation | deviation |
| Ex. 1 | 0.5 | 2 | 3 | 4.8 | 3.8 | 0.33 | ◯ |
| Ex. 2 | 0.5 | 4 | 5 | 5.6 | 4.4 | 0.41 | ◯ |
| Ex. 3 | 0.5 | 5 | 7 | 6.1 | 4.3 | 0.54 | Δ |
| Ex. 4 | 0.4 | 5 | 7 | 6.1 | 4.4 | 0.64 | Δ |
| C. Ex. 1 | 0.5 | 2 | 12 | 8.2 | 2.1 | 2.58 | X |
| C. Ex. 2 | 0.5 | 5 | 12 | 9.5 | 3.2 | 2.25 | X |
| C. Ex. 3 | 0.5 | — | — | 0.5 | −0.1 | 0.16 | ◯ |

Heat shrinkage factor (%) in TD direction

| | | | | Evaluation of |
|---|---|---|---|---|
| | Maximum | Minimum | Standard | standard |
| | value | value | deviation | deviation |
| Ex. 1 | 5.1 | 3.1 | 0.75 | ◯ |
| Ex. 2 | 6.2 | 4.2 | 0.85 | ◯ |
| Ex. 3 | 6.7 | 4.3 | 0.95 | ◯ |
| Ex. 4 | 6.9 | 4.4 | 0.98 | ◯ |
| C. Ex. 1 | 11.2 | 1.7 | 1.74 | X |
| C. Ex. 2 | 13.2 | 2.1 | 1.68 | X |
| C. Ex. 3 | 0.4 | 0.0 | 0.12 | ◯ |

| | Thickness (mm) in TD direction | | | | | |
|---|---|---|---|---|---|---|
| | Maximum | Minimum | Standard | Evaluation of | Foreign | |
| | value | value | deviation | standard deviation | matter | Die line |
| Ex. 1 | 0.51 | 0.48 | 3.9 | ◯ | ◯ | ◯ |
| Ex. 2 | 0.52 | 0.48 | 4.5 | ◯ | ◯ | ◯ |
| Ex. 3 | 0.52 | 0.48 | 4.3 | ◯ | ◯ | ◯ |
| Ex. 4 | 0.41 | 0.38 | 3.9 | ◯ | ◯ | ◯ |
| C. Ex. 1 | 0.53 | 0.47 | 10.6 | X | ◯ | ◯ |
| C. Ex. 2 | 0.54 | 0.47 | 9.2 | X | ◯ | ◯ |
| C. Ex. 3 | 0.52 | 0.48 | 10.5 | X | X | X |

Ex.: Example
C. Ex.: Comparative Example

### EFFECT OF THE INVENTION

The sheet of the present invention has small variations in thickness in the transverse direction (TD), a good appearance and a small heat shrinkage factor and small variations thereof at any part of the sheet at the time of thermoforming. Therefore, the sheet of the present invention has excellent dimensional stability and shapability. According to the production process of the present invention, a sheet which has small variations in thickness in the transverse direction (TD), a good appearance, and a small heat shrinkage factor and small variations thereof at any part of the sheet at the time of thermoforming can be manufactured.

1. A sheet made of a polycarbonate resin and having a thickness of 0.2 to 2.0 mm, a heat shrinkage factor in the extrusion direction (MD) of 2 to 8% when it is heated at 180° C. for 10 minutes, and a standard division of heat shrinkage factor in the transverse direction (TD) of the sheet of 1.5 or less.

2. The sheet according to claim 1 which has a standard deviation of thickness in the transverse direction (TD) of 8 or less.

3. A molded article obtained by thermoforming the sheet of claim 1.

4. A process for producing the sheet of claim 1, comprising the steps of:
(i) melt extruding a polycarbonate resin into a sheet form from a T die;
(ii) cooling the sheet by pressure holding it between cooling rolls; and
(iii) transferring the sheet by a transfer roll, wherein the rolling force at the time of pressure holding the sheet between the cooling rolls is 2 to 10 tons.

5. The process according to claim 4, wherein there are first, second and third cooling rolls arranged in the extrusion direction, the polycarbonate resin is melt extruded between the first roll and the second roll, the temperature of the first roll is 105 to 120° C., the temperature of the second roll is 105 to 120° C., and the temperature of the third roll is 130 to 150° C.
